(19) United States
(12) Patent Application Publication
(10) Pub. No.: US 2010/0239854 A1
(43) Pub. Date: Sep. 23, 2010

(54) METALLIC MATERIAL COATED WITH CARBON FILM

(75) Inventors: Shi-Kun CHEN, Taichung (TW); Tse-Hao KO, Taichung (TW); Tsung-Shune CHIN, Taichung (TW); Chih-Yeh CHUNG, Taichung (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: FENG CHIA UNIVERSITY, Taichung (TW)

(21) Appl. No.: 12/553,634

(22) Filed: Sep. 3, 2009

(30) Foreign Application Priority Data
Mar. 20, 2009 (TW) 098109105

(51) Int. Cl. B32B 15/04

(52) U.S. Cl. 428/336; 428/457; 428/335

(57) ABSTRACT

A metallic material coated with a carbon film is provided. The coated metallic material comprises a metal substrate and a carbon film, wherein the carbon film includes an amorphous phase and a graphite-like phase, and in some embodiments an extra diffusion layer onto the metal substrate underneath the carbon film. The carbon film can be a single layer comprising of two carbon phases, amorphous carbon as the matrix and embedded graphite-like granules. The carbon film can also be multilayers with alternate amorphous carbon film and graphite-like carbon film.

This application claims priority to Taiwan Patent Application No. 098109105 filed on Mar. 20, 2009, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a metallic material coated with a carbon film. In particular, the present invention provides a metallic material coated with a carbon film which is useful for the preparation of materials for bipolar plates of fuel cells.

2. Descriptions of the Related Art

As a result of the shortage of energy resources and the greenhouse effect on Earth, the hydrogen fuel cell has been developed extensively. Unlike a disposable non-rechargeable battery, the fuel cell will not lead to environmental problems; and also, the fuel cell does not require a time-consuming charging process of a conventional rechargeable battery. Also, the emissions of the fuel cell (mostly water) are harmless to the environment.

In general, the fuel cell comprises a membrane-electrode assembly (MEA), a gas diffusion layer and bipolar plates with gas channels. Bipolar plates constitute about 90% volume of a fuel cell, and thus, bipolar plates are the most critical factor of the cost, weight and power density of a fuel cell. Since bipolar plates have to collect and transfer the current, distribute the gas and manage the heat and water produced, they are preferably provided with excellent electrical and thermal conductivity, mechanical strength, corrosion resistance and chemical stability.

Known materials of bipolar plates are mainly graphite, a composite material or a metallic material with a better rigidity. Graphite has been most commonly used for a long time and has an excellent electric conductivity and corrosion resistance, but it has several deficiencies such as the difficulty in processing (such as numerical-controlled machining), insufficient mechanical strength, poor sealing property, and very expensive. Although the composite material, such as a polymer/graphite composite material, has a lower price, it is not yet widely used due to its poor mechanical strength and imperfect electric conductivity as compared with commercial graphite. Therefore, metal bipolar plates, with a low price as well as an electric conductivity and mechanical strength better than that of commercial graphite, have been regarded as the mainstream of bipolar plates of fuel cells.

However, the application of metallic materials as bipolar plates of a fuel cell is not perfect. One of the disadvantages is that metallic materials (e.g., stainless steel, Ni alloy, Al alloy, etc.) corrode easily and release metal ions under the severe operating conditions of fuel cells, thereby affecting the service life of fuel cells. Thus, the corrosion resistance of the metal surface has to be improved to advance the applications. One of the methods is to coat the metal substrate surface with a layer of a noble metal (e.g., Ag, Au, Pt, Pd, etc.). However, this will enormously raise the cost. Moreover, a carbon film on the metal substrate surface has been applied to block the surface from corrosion. For example, U.S. Pat. No. 5,068,126 formed a pile layer of graphite particles on the surface of different alloy substrates by a thermal chemical vapor deposition (thermal CVD); coating a metal alloy film on the surface of the pile layer of graphite particles by a physical vapor deposition method; and finally, depositing a pile layer of carbon particles on the surface of the metal alloy film. However, this method is complicated. Furthermore, the metal coated with a carbon pile layer thus prepared cannot be used in such a severe corrosion environment for fuel cells because the graphite and carbon pile layers are piled up by particles which are neither continuous nor dense carbon films. U.S. Pat. No. 4,645,713 also provided a method for preparing a conductive graphite film, which deposits carbon film on a metal substrate by a plasma-discharge chemical vapor deposition method. However, according to this method, an additional high temperature (1500° C. to 3300° C.) annealing process is required for the deposited carbon film to provide a graphite film with an excellent electric conductivity. The method is restricted thereby since metal substrates usually cannot bear such high temperatures. Another known method (such as that provided by U.S. patent application Ser. No. 11/798,078) is to provide a catalyst film on a metal substrate surface by a process, for example, sputtering, electroplating or electroless plating, and then forming a continuous and dense carbon film on the surface of the catalyst layer. However, the preparation of the catalyst film will greatly raise the cost of raw materials and processes. The simplification of the process is very important for the development of metal bipolar plates.

The inventors of the subject patent application invented methods by which a metallic material coated with a continuous and dense carbon film can be easily prepared without using any noble metals or forming a catalyst layer in advance. The carbon film thus formed adheres firmly on the metal surface; has an excellent electric conductivity and a two-phase structure (an amorphous phase and a graphite-like phase); withstands the attack of strong acids/bases; and shows better corrosion resistance than that of bulk graphite plate. The carbon films coated metallic material of the present invention thereby can be used in a severe chemical/electrochemical condition and replace the expensive high-density graphite bulk material in specific applications.

### SUMMARY OF THE INVENTION

One objective of the present invention is to provide a metallic material coated with a dense and continuous carbon film, comprising:
a metal substrate; and
a continuous and dense carbon film, composed of an amorphous phase and a graphite-like phase.

The aforesaid objective, the technology features and the advantages of the present invention are further described in the following paragraphs with specific embodiments and drawings appended.

### BRIEF DESCRIPTION OF THE DRAWINGS

FIG. 1 is a cross-sectional drawing of an embodiment of a metallic material coated with a carbon film according to the present invention.

FIG. 2A is a cross-sectional drawing of another embodiment of a metallic material coated with a carbon film according to the present invention.

FIG. 2B is a cross-sectional drawing of another embodiment of a metallic material coated with a carbon film according to the present invention.

FIG. 2C is a cross-sectional drawing of yet another embodiment of a metallic material coated with a carbon film according to the present invention.

FIG. 3 is a Tafel plot of an embodiment of several materials, wherein one of them is a metallic material coated with a carbon film according to the present invention.

FIG. 4 is a graph showing the variation of interface contact resistance (ICR) versus stress for an embodiment of several materials, wherein one of them is a metallic material coated with a carbon film according to the present invention.

FIG. 5 is a plot of discharge voltage versus current of fuel cells, wherein one of the fuel cells comprises bipolar plates made from the metallic material coated with a carbon film according to the present invention.

### DESCRIPTION OF THE PREFERRED EMBODIMENT

The following will concretely describe specific embodiments according to the present invention along with the drawings appended. However, the present invention may be embodied in other embodiments without departing from the spirit of the present invention. The scope of protection of the present invention should not be limited to the embodiments described in the specification. In addition, for clarity, the size of each element and each area may be exaggerated in the figures and is not depicted as their actual scale.

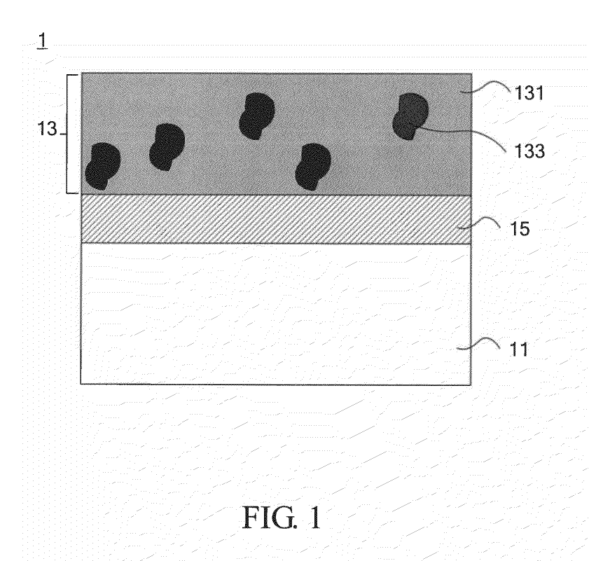

The present invention provides a metallic material coated with a carbon film. As implied by the term, the metallic material comprises a metal substrate and a carbon film located on the surface of metal substrate. According to some embodiments of the present invention, the metallic material further comprises a diffusion layer located between the metal substrate and the carbon film. FIG. 1 shows an embodiment of the metallic material according to the present invention. The metallic material 1 coated with a carbon film comprises a metal substrate 11, a carbon film 13 and a diffusion layer 15 located between the metal substrate 11 and the carbon film 13. The carbon film 13 includes an amorphous phase 131 and a graphite-like phase 133.

Any suitable metal can be used as the metal substrate 11 of the present invention. The softening temperature (or deflection temperature, i.e., the temperature where materials become soft and/or dramatically lose their mechanical strength when being heated) of the selected metal should be higher than the temperature applied during the preparation, i.e., the temperature applied for forming the carbon film 13 on the metal substrate 11. For example, the metal substrate 11 may be composed of an ingredient selected from a group consisting of iron (Fe), copper (Cu), aluminum (Al), nickel (Ni), titanium (Ti) and alloys of the aforesaid metals, and preferably selected from a group consisting of a stainless steel, a plain carbon steel, a low-alloy steel, a copper alloy, an aluminum alloy, a nickel alloy and a titanium alloy. In some embodiments of the present invention, the metal substrate 11 is composed of stainless steel or plain carbon steel.

With respect to the structure of the carbon layer, although a carbon layer containing single phase graphite has a better electric conductivity, corrosive liquids (such as strong acids) can easily penetrate through the interlayer spacing of the graphite phase and attack the metal substrate underneath. After numerous tests, the inventors of the present invention found that the carbon layer 13 composing of two phase, one an amorphous phase and the other a graphite-like phase has, in addition to a high electric conductivity, an excellent corrosion resistance, and thereby, can effectively protect the underneath metal substrate 11 from corrosion. Such improvement may be observed from the following embodiments.

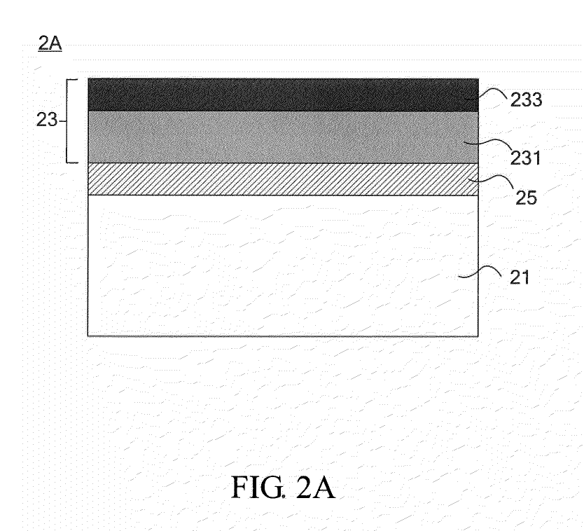

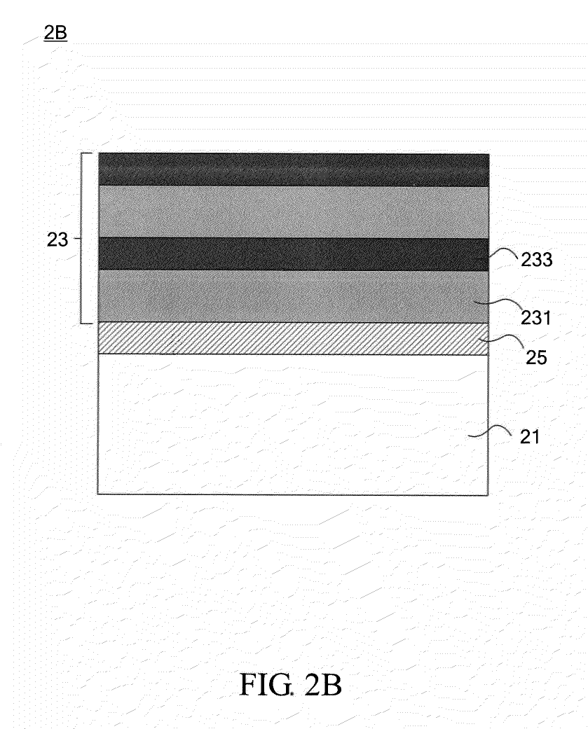

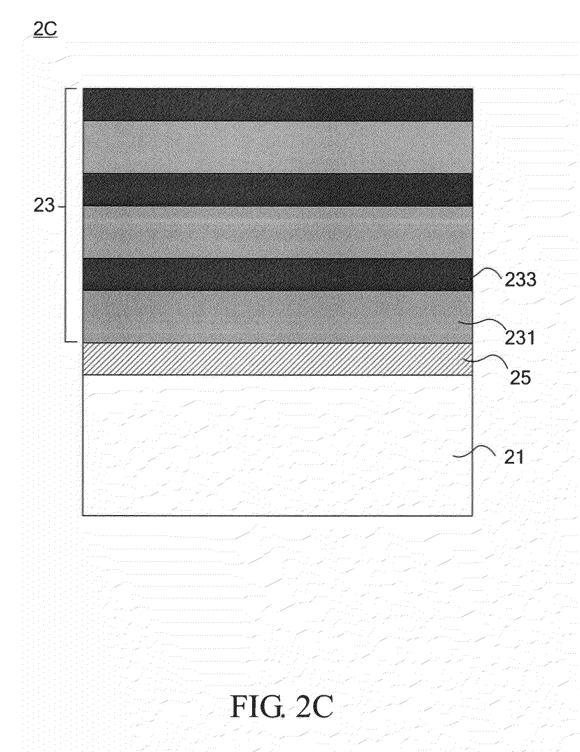

The carbon film on the metallic material according to the present invention may have a single-layer structure or a multi-layer structure. For example, referring to the metallic material 1 shown in FIG. 1, the carbon film 13 is a single-layer structure composing of the amorphous phase 131 intermixed with the graphite-like granule phase 133. Or, referring to the metallic materials 2A to 2C shown in FIGS. 2A to 2C, the carbon film 23 comprises one or more amorphous layer(s) 231 and one or more graphite-like layer(s) 233, wherein the amorphous layer(s) 231 and the graphite-like layer(s) 233 alternately stack with each other. In the embodiment where the carbon film 13 is a single-layer structure, the carbon film generally has a thickness ranging from about 0.5 μm to about 50 μm, preferably from about 1 μm to about 20 μm. In general, a carbon film (with a single-layer structure) having a thickness of less than about 0.5 μm cannot effectively block a corrosive environment; while a carbon film (with a single-layer structure) having a thickness of more than 50 μm will lead to peeling or chapping of the carbon film. In the embodiment where the carbon film 23 is a multi-layer structure, the thickness of the amorphous layer 231 generally ranges from about 0.5 μm to about 5 μm, preferably from about 1 μm to about 2 μm, but is not limited thereto. Also, the thickness of the graphite-like layer 233 generally ranges from about 0.05 μm to about 2 μm, preferably from about 0.1 μm to about 1 μm, but is not limited thereto. The total thickness of the carbon film 23 is generally less than about 50 μm to prevent the films from peeling or chapping.

The structure of a carbon film is usually identified by a micro Raman spectrometer. That is, the Raman spectrum of a sample to be analyzed is measured by a micro Raman spectrometer using a light source with a specific wavelength; and then the structure of the carbon film is analyzed by calculating the Raman R value as follows:

R=I_{D}/I_{G},

wherein, I_{D} is the integral intensity of D-band of the Raman spectrum and I_{G} is the integral intensity of G-band of the Raman spectrum. The Raman R value of the carbon film, with a single-layer structure, on the metallic material according to the present invention ranges from about 0.35 to about 1.95, preferably from about 0.5 to about 1.8, when an argon laser with a wavelength of about 514.5 nm is applied as the light source. For the metallic material with a multi-layer carbon structure according to the present invention, the Raman R value of the amorphous layer ranges from about 0.35 to about 1.95, preferably from about 0.50 to about 1.80; and the Raman R value of the graphite-like layer is less than about 0.35, preferably less than about 0.30.

In the embodiment that the metallic material further comprises a diffusion layer located between the metal substrate and the carbon film, the diffusion layer exhibits a high adhesion to the metal substrate as well as to the carbon film, and thus can be used as an adhesive layer for the metal substrate and the carbon film, which is advantageous to coat the carbon film on the metal substrate more tightly, thereby the peeling or chapping of the carbon film often encountered in the prior art is overcome. The diffusion layer is composed of a mixture, which comprises ingredients of the metal substrate, carbides of the ingredient and free carbon phases. The free carbon phases contained in the diffusion layer are present in a structure of an amorphous phase, a graphite-like phase or a mix-phase of the two; and the diffusion layer does not possess the corrosion-resistance capability of a pure carbon film. For example, in some embodiments of the present invention, the diffusion layer is a mixed layer with a structure unlike the metal substrate and the carbon layer. In general, the diffusion layer has a thickness ranging from about 0.1 μm to about 5 μm, preferably from about 0.2 μm to about 2 μm. The thickness of the diffusion layer can be measured by a glow-discharge spectrometer (GDS) and an X-ray photoelectron spectrometer (XPS). Furthermore, since the carbon concentration of the metal substrate is almost zero and that of the carbon film is almost 100%, the thickness of the diffusion layer defined herein represents the distance from the position with a carbon concentration of 99 atom % to the position with a carbon concentration of 50 atom %, under the carbon film.

The metallic material coated with a carbon film according to the present invention is provided with not only a good electric conductivity but also an excellent corrosion resistance. In some embodiments according to the present invention, the metallic material coated with a carbon film has a sheet resistance value ranging from about 5×10⁻³ Ω/□ (Ohm per square) to about 5×10⁻⁵ Ω/□, more specifically, e.g., from about 5×10⁻³ Ω/□ about 5×10⁻⁴ Ω/□. The metallic material according to the present invention also has good mechanical strength and sealing properties. The present invention is especially suitable for use, but not limited, as bipolar plates of a fuel cell. The present invention will be also useful to all other electrochemical cells if applicable.

Any suitable method may be used to prepare the metallic material coated with a carbon film according to the present invention. For example, a polymer thermal decomposition method can be used, wherein the metal substrate is firstly coated with a resin, and then subjected to a high temperature thermal decomposition process to generate a carbon diffusion layer and a carbon film. Also, a chemical vapor deposition method may be used to directly generate a diffusion layer and a carbon film on the metal substrate. Alternatively, a physical vapor deposition method may be used to first form a carbon film on the metal substrate, followed by performing a high-temperature annealing process to form a desired diffusion layer between the metal substrate and the carbon film. The chemical vapor deposition methods include, for example, thermal chemical vapor deposition, plasma enhanced chemical vapor deposition, microwave chemical vapor deposition, etc.

For example, the chemical vapor deposition method for preparing the carbon film coating on metallic material according to the present invention may be carried out with the following steps: feeding a carbon-containing raw material via a carrying gas (e.g., hydrogen or argon) into a reaction chamber where a metal substrate is placed, and thereby forming a diffusion layer and a carbon layer on the surface of metal substrate. The chemical vapor deposition is preferably carried out at a temperature ranging from about 400° C. to about 1200° C. more preferably from about 400° C. to about 1000° C.

The carbon-containing raw material used in the chemical vapor deposition may be in the solid, liquid or gas state and must be able to be dehydrogenated through a low temperature cracking process to provide carbon atoms required for forming a carbon film structure. For example, the carbon-containing raw material can be selected from a group consisting of C₁-C₆ alkanes, C₂-C₆ alkenes, C₂-C₆ alkynes, C₁-C₆ alcohols and combinations thereof, preferably selected from a group consisting of methane, ethylene, acetylene, methanol, ethanol and combinations thereof. In some embodiments according to the present invention, methane and/or acetylene are/is used as the carbon-containing raw material.

The property of the carbon film generated in the chemical vapor deposition step will be affected by the species and concentration of the carbon-containing raw material and the process parameter of chemical vapor deposition (such as the reaction temperature, heating rate and isothermal soaking time). When preparing a single-layer carbon film including both amorphous phase and graphite-like phase (like the embodiment depicted in FIG. 1), the concentration ratio of the amorphous phase to the graphite-like phase in the carbon film can be adjusted by controlling the temperature of the chemical vapor deposition step. In general, a lower reaction temperature results in a higher volume ratio of the amorphous phase in the formed carbon film. Conversely, a higher reaction temperature results in a higher volume ratio of the graphite-like phase in the carbon film. For a middle temperature, a typical two-phase mixture structure occurs in the carbon film. For example, at a reaction temperature of about 800° C. to 900° C. for 120 to 300 minutes, a diffusion layer is first formed on the substrate via the carbon diffusion reaction; and then a carbon film, based on the amorphous phase and graphite-like phase, is formed on the diffusion layer by using a gas mixture of a carbon-containing raw material: acetylene (40 to 60% by volume) and a carrying gas: hydrogen.

Also, a carbon film with a multi-layer structure, which is composed of one or more amorphous layer(s) and one or more graphite-like layer(s) stacked with each other alternately, can be formed by using a chemical vapor deposition with an operation model where a high temperature and a low temperature are used alternately. For example, a gas mixture of a carbon-containing raw material (methane) and a carrying gas (hydrogen) is used to carry out a chemical vapor deposition to form a diffusion layer and an amorphous layer at a lower temperature (e.g., about 600° C. to about 800° C.). The reaction temperature is then increased to a higher temperature (e.g., about 900° C. to about 1000° C.) with a heating rate of about 10° C./min to about 30° C./min for again carrying out the chemical vapor deposition to form a graphite-like layer on the amorphous layer, thereby providing a carbon film with a multi-layer structure which at least includes one amorphous layer and one graphite-like layer. If necessary, a carbon film with a multi-layer structure which includes two or more pairs of the amorphous layer and the graphite-like layer can be prepared by repeating the above low-temperature and high-temperature steps.

The embodiments below are illustrated to further delineate the present invention.

### Example 1

### Effect of Reaction Temperature on Crystal Structure of Carbon Film

A metal substrate of AISI 1020 plain carbon steel was placed in a thermal CVD furnace, then reduced and activated at 850° C. under 1 atm of hydrogen to remove residual organics or oxides thereon. After cooling down to the reaction temperature of 600° C., a gas mixture of methane and hydrogen (methane concentration: 50% by volume) was then fed into the reaction furnace for 60 minutes to form a diffusion layer and a carbon film on the metal substrate surface. The furnace was then cooled down to a room temperature to provide a metallic material 1-A coated with a carbon film according to the present invention. The R value of the carbon film on the surface of metallic material 1-A was measured by a micro Raman spectrometer as listed in Table 1.

Metallic materials 1-B, 1-C, 1-D and 1-E coated with a carbon film according to the present invention were prepared by repeating the above steps while the temperature of the chemical vapor deposition for forming the carbon film were changed to 700° C., 800° C., 900° C. and 1000° C., respectively. The R value of carbon film on each metallic material was measured by a micro Raman spectrometer. Crystal structure of the carbon film on each metallic material was further examined by a transmission electron microscope (TEM). The result is also shown in Table 1.

TABLE 1

| Metallic | Reaction | | Crystal phase of the carbon |
|---|---|---|---|
| material | temperature (° C.) | R value | film |
| 1-A | 600 | 3.38 | Amorphous phase |
| 1-B | 700 | 2.92 | Mostly amorphous phase |
| 1-C | 800 | 1.48 | Amorphous phase and some |
| | | | graphite-like phase |
| 1-D | 900 | 0.54 | Graphite-like phase and some |
| | | | amorphous phase |
| 1-E | 1000 | 0.06 | Graphite-like phase |

As shown in Table 1, when the other conditions are the same, the R value of the carbon film on the metallic materials decreases with the increase of the reaction temperature for forming the carbon film. When the reaction temperature is higher than 900° C., the R value is almost zero and the carbon film has a great amount of the graphite-like phase. On the contrary, the carbon film is mostly composed of an amorphous phase with only a small amount of graphite-like phase when the reaction temperature is lower than 800° C. When the reaction temperature is lower than 700° C., the carbon film is substantially composed of an amorphous phase. Namely, the reaction temperature of chemical vapor deposition critically affects the R value or the crystal phase of the carbon film.

### Example 2

### Corrosion Resistance Test

A metal substrate of AISI 304 stainless steel was placed in a thermal CVD furnace, then reduced and activated at 850° C. under a high vacuum of 5×10⁻⁶ torr. A gas mixture of acetylene and hydrogen (acetylene concentration: 50% by volume) was fed into the furnace for carrying out a chemical vapor deposition process at 850° C. to form a diffusion layer and a carbon film on the metal substrate surface. The furnace was then cooled down to room temperature to provide the metallic material 1 coated with a carbon film as shown in FIG. 1. According to the examination of TEM, the carbon structure of the metallic material 1 only contains a small amount of graphite-like phase 133 (about 10%).

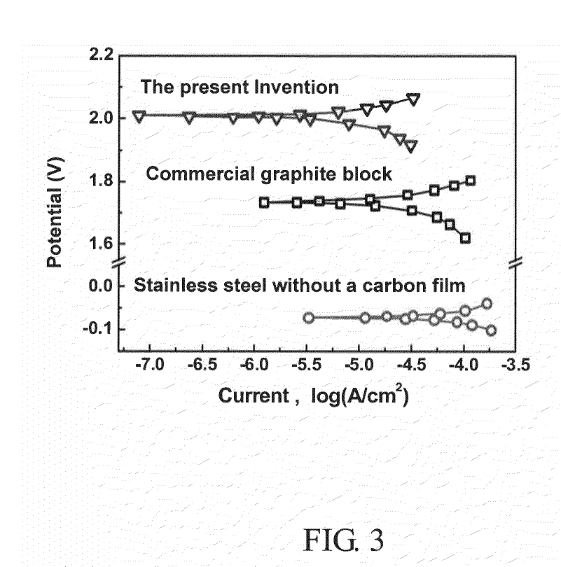

The corrosion potentials of the prepared metallic material 1, the metal substrate used (i.e., AISI 304 stainless steel) and a commercial graphite bulk material (POCO, AXF-5QCF) were tested by Tafel method via potentiodynamic polarization in 0.5 M H₂SO₄ solution at room temperature. The obtained Tafel plots are shown in FIG. 3.

The metallic material 1 according to the present invention exhibits a positive corrosion potential of about 2.05 volts (V), thus indicates no characteristics of metallic corrosion. The corrosion potential is not only higher than the stainless steel applied (with a negative corrosion potential of about −0.10V) but also higher than the commercial graphite bulk material (with a corrosion potential of about 1.73V). In this case, the higher the positive potential the better is the corrosion resistance. Thus, the carbon-coated stainless steel plate shows manifestly better corrosion resistance than that of commercial graphite plate.

### Example 3

### Resistivity Test

A metal substrate of AISI 304 stainless steel was placed in a thermal CVD furnace, then reduced and activated at 850° C. under 1 atm of hydrogen. After the furnace was cooled down to 700° C., a gas mixture of methane and hydrogen (methane concentration: 80% by volume) was fed into the furnace. The furnace was held at 700° C. for 60 minutes to form a diffusion layer on the stainless steel substrate and an amorphous layer on the diffusion layer. The furnace was then raised to 950° C. with a heating rate of 20° C./min and held for 10 minutes to form a graphite-like layer on the amorphous layer. Next, the reaction furnace was cooled down to room temperature to provide the metallic material 2A as shown in FIG. 2A, i.e., with one pair of ‘amorphous layer and graphite-like layer’.

The above steps were carried out repeatedly. Nonetheless, after the graphite-like layer was formed, the reaction temperature was lowered to 700° C. with a rate of 20° C./min and held for 10 minutes to form another amorphous layer. The reaction temperature was then raised to 950° C. with a heating rate of 20° C./min and held for 10 minutes to form a graphite-like layer on the amorphous layer just formed. Next, the reaction chamber was cooled down to room temperature to provide the metallic material 2B as shown in FIG. 2B, i.e., with two pairs of ‘amorphous layers and graphite-like layers’.

The above steps were carried out repeatedly once again and the third pair of an amorphous layer and a graphite-like layer was formed on the second pair. The reaction furnace was then cooled down to a room temperature to provide the metallic material 2C as shown in FIG. 2C, i.e. with three pairs of ‘amorphous layers and graphite-like layers’.

The resistivity of the prepared metallic materials 2A, 2B, 2C, a commercial graphite bulk material (POCO, AXF-5QCF) and the metal substrate used (i.e., bare AISI 304 stainless steel) was tested. The result is shown in Table 2.

TABLE 2

| | Number of pairs | | Sheet |
|---|---|---|---|
| | of the amorphous | Thickness of | resistance |
| | layer and the | the carbon film | value |
| Sample | graphite-like layer | (μm) | (10⁻⁴ Ω/□) |
| Metal substrate | — | — | 2.75 |
| Metallic material 2A | 1 | 3.8 | 4.78 |
| Metallic material 2B | 2 | 7.8 | 5.46 |
| Metallic material 2C | 3 | 11.6 | 5.98 |
| Commercial graphite | — | — | 6.22 |
| bulk material | | | |

According to Table 2, the sheet resistance value of the metallic material coated with a carbon film according to the present invention is close to that of the stainless steel, and the sheet resistance value increases slightly when the number of pairs of carbon film increases. The sheet resistance value of the metallic material with three pairs of the amorphous layers and the graphite-like layers is still better than that of the commercial graphite bulk material. In other words, the carbon-film coated metallic material according to the present invention, by means of the carbon film with a multiple-layer structure, provides corrosion resistance and also retains excellent electric conductivity; and thereby, is suitable for use as the material of bipolar plates of a fuel cell.

### Example 4

### Interfacial Contact Resistance (ICR) Test

A metal substrate of AISI 1008 plain carbon steel was placed in a reaction furnace and reduced and activated at 850° C. under 1 atm hydrogen gas. After the furnace was cooled down to 700° C., a gas mixture of acetylene and hydrogen (acetylene concentration: 80% by volume) was fed into the furnace. The furnace was held at 700° C. for 60 minutes to form a diffusion layer on the plain carbon steel substrate and an amorphous layer on the diffusion layer. The furnace was then raised to 930° C. with a heating rate of 20° C./min and held for 10 minutes to form a graphite-like layer on top of the amorphous layer. The above steps were repeated twice to provide a metallic material coated with three pairs of amorphous layers and graphite-like layers.

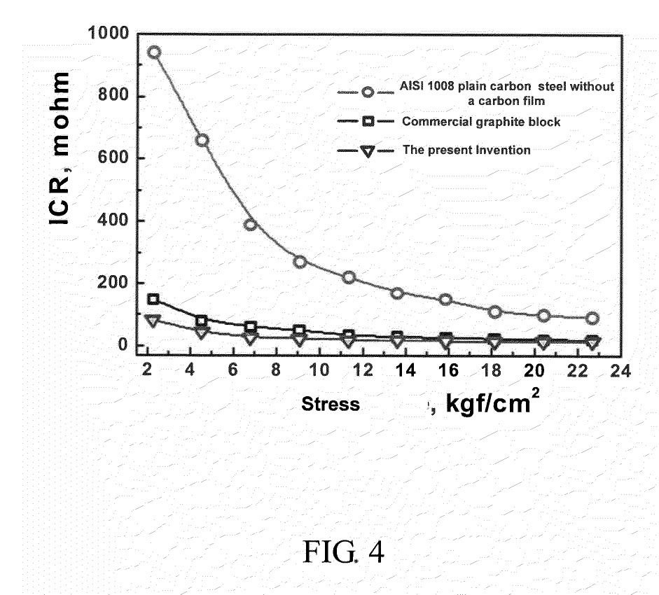

On the side of carbon-coated metallic material comes into contact with a commercial conductive carbon paper (Toray, TGPH090), which is usually used as a material of a gas diffusion layer of a fuel cell. They were then clamped between two copper plates for the testing. An ohmmeter was used to measure the variation of the ICR under different stresses (load per area) of the copper clips. The variation of the ICR of commercial graphite (POCO, AXF-5QCF) and bare AISI 1008 plain carbon steel were measured in the same way. The result of the measurements is shown in FIG. 4.

With respect to the fuel cell, the ICR through the bipolar plates and gas diffusion layer is a critical factor affecting the internal impedance of the fuel cell. As shown in FIG. 4, the ICR of the carbon-film coated metallic material according to the present invention is much lower than that of AISI 1008 plain carbon steel without coating a carbon film and also that of the commercial graphite bulk material. The metallic material according to the present invention will provide satisfactory internal impedance when used in a fuel cell.

### Example 5

### Performance Test of the Assembled Fuel Cell

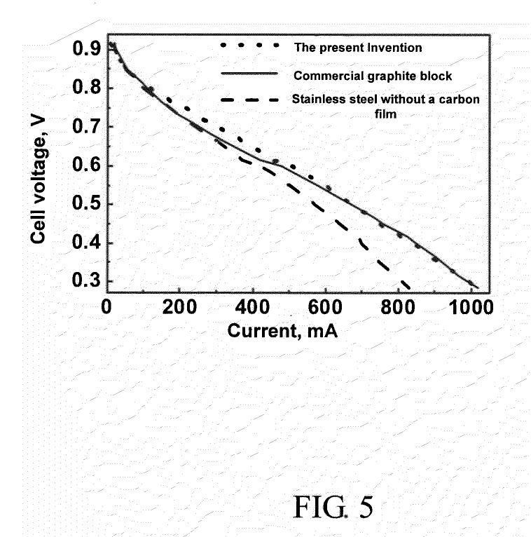

AISI 304 stainless steel substrate was processed to provide gas channels of bipolar plates of a fuel cell. A metallic material coated with a carbon film including an amorphous phase and a graphite-like phase was provided using the steps of Example 2. Fuel cells A, B and C were provided with bipolar plates respectively made of AISI 304 stainless steel coated with a carbon film according to the present invention, commercial graphite (POCO, AXF-5QCF) and AISI 304 stainless steel without coating a carbon film. All other parts, such as membrane electrode assembly and gas-diffusion layer, were the same for the three fuel cells. The fuel cells were then analyzed by a fuel cell performance testing system under the same hydrogen supply condition at 40° C. The curves of discharge voltage versus current (polarization curves) of the cells were measured after the fuel cells had been operated with a voltage of 0.6 V for 100 hrs. The results are shown in FIG. 5.

As shown in FIG. 5, as compared with fuel cells A and B, after the test with a fixed voltage (0.6V) for 100 hrs, the current output of fuel cell C decays more obviously than the others. After the 100-hrs test, the current output of fuel cell A is about 480 mA at a constant voltage of 0.6 V and that of fuel cell C is about 400 mA which is 17% less than that of fuel cell A. This fact indicates that a metallic material without coating a carbon film cannot resist a severe chemical/electrochemical environment and is not suitable for use as a material of fuel-cell bipolar plates. The testing result of fuel cell A, which uses the metallic material coated with a carbon film according to the present invention as bipolar plates, is superior to or overlaps with that of fuel cell B which uses commercial graphite bipolar plates. In other words, when the metallic material coated with a carbon film according to the present invention is used as the bipolar plates of a fuel cell, the disadvantages of metallic materials (such as poor corrosion resistance) and commercial graphite (such as poor mechanical properties) can be overcome and an equal performance with that of commercial graphite can be provided.

Given the above, the metallic material coated with a multi-phase or multi-layer carbon film (i.e., a carbon film at least including a amorphous phase and a graphite-like phase) according to the present invention, as bipolar plates of a fuel cell, has advantages of commercial graphite (e.g., excellent electric conductivity and corrosion resistance) and metallic materials (e.g., excellent mechanical and sealing properties) and provides very high fuel-cell performance. Furthermore, the presence of the diffusion layer provides a tight adhesion between the metal substrate and the carbon film so that the peeling or chapping of the carbon film which occasionally occurs can be overcome.

The above disclosure is related to the detailed technical contents and inventive features thereof. People skilled in this field may proceed with a variety of modifications and replacements based on the disclosures and suggestions of the present invention as described without departing from the characteristics thereof. Nevertheless, although such modifications and replacements are not fully disclosed in the above descriptions, they have substantially been covered in the following claims as appended.

What is claimed is:

1. A metallic material coated with a carbon film, comprising:
a metal substrate; and
a continuous and dense carbon film, composed of an amorphous phase and a graphite-like phase.

2. The metallic material of claim 1, wherein the metal substrate comprises at least one ingredient selected from a group consisting of iron (Fe), copper (Cu), aluminum (Al), nickel (Ni), titanium (Ti) and alloys of the aforesaid metals.

3. The metallic material of claim 1, wherein the metal substrate comprises at least one selected from a group consisting of a stainless steel, a plain carbon steel, a low-alloy steel, a copper alloy, an aluminum alloy, a nickel alloy and a titanium alloy.

4. The metallic material of claim 1, wherein the metal substrate is composed of a stainless steel or a plain carbon steel.

5. The metallic material of claim 1, wherein the carbon film has a single-layer structure and a thickness ranging from about 0.5 μm to about 50 μm.

6. The metallic material of claim 5, wherein the carbon film has a thickness ranging from about 1 μm to about 20 μm.

7. The metallic material of claim 5, wherein the carbon film has a Raman R value ranging from about 0.35 to about 1.95, wherein the Raman R value is tested by using an argon laser having a wavelength of about 514.5 nm as a testing light source.

8. The metallic material of claim 7, wherein the carbon film has a Raman R value ranging from about 0.5 to about 1.8.

9. The metallic material of claim 1, wherein the carbon film has a multi-layer structure.

10. The metallic material of claim 9, wherein the carbon film comprises one or more amorphous layer(s) and one or more graphite-like layer(s), wherein the amorphous layer(s) arid the graphite-like layer(s) stack with each other alternately.

11. The metallic material of claim 10, wherein the amorphous layer has a Raman R value ranging from about 0.35 to about 1.95 and the graphite-like layer has a Raman R value of less than about 0.35, wherein the Raman R values are tested by using an argon laser having a wavelength of about 514.5 nm as a testing light source.

12. The metallic material of claim 11, wherein the amorphous layer has a Raman R value ranging from about 0.5 to about 1.8 and the graphite-like layer has a Raman R value of less than about 0.3.

13. The metallic material of claim 10, wherein the amorphous layer has a thickness ranging from about 0.5 μm to about 5 μm and the graphite-like layer has a thickness ranging from about 0.05 μm to about 2 μm.

14. The metallic material of claim 13, wherein the amorphous layer has a thickness ranging from about 1 μm to about 2 μm and the graphite-like layer has a thickness ranging from about 0.1 μm to about 1 μm.

15. The metallic material of claim 9, wherein the carbon film has a thickness of less than about 50 μm.

16. The metallic material of claim 1, which has a sheet resistance value ranging from about 5×10⁻⁵ Ω/□ to about 5×10⁻³ Ω/□.

17. The metallic material of claim 1, which has a sheet resistance value ranging from about 1×10⁻⁴ Ω/□ to about 1×10⁻³ Ω/□.

18. The metallic material of claim 1, further comprising a diffusion layer onto the metal substrate and underneath the carbon film, wherein the diffusion layer comprises ingredients of the metal substrate, carbides of the ingredients and pure carbon phases.

19. The metallic material of claim 18, wherein the diffusion layer has a thickness ranging from about 0.1 μm to about 5 μm.

20. The metallic material of claim 19, wherein the diffusion layer has a thickness ranging from about 0.2 μm to about 2 μm.
